(19) United States
(12) Patent Application Publication
(10) Pub. No.: US 2006/0040742 A1
(43) Pub. Date: Feb. 23, 2006

(54) Methods, systems, and computer program products for coordinating peer-to-peer communication sessions across a communication network by uploading a coordination module to a hosting server

(76) Inventors: Steven Allan Wright, Roswell, GA (US); Thomas Arnold Anschutz, Alpharetta, GA (US)

Correspondence Address: MYERS BIGEL SIBLEY & SAJOVEC, P.A., P.O. BOX 37428, RALEIGH, NC, 27627, US

(21) Appl. No.: 10/922,550

(22) Filed: Aug. 20, 2004

(51) Int. Cl. G06F 19/00; G06F 17/00

(52) U.S. Cl. 463/42

(57) ABSTRACT

A communication network includes a hosting server and a plurality of data processing systems and is operated by uploading a coordination module from one of the plurality of data processing systems to the hosting server. The game hosting server coordinates peer-to-peer communication sessions among a plurality of users associated with the plurality of data processing systems.

### FIELD OF THE INVENTION

The present invention relates to communication networks, and, more particularly, to hosting of peer-to-peer communication sessions, such as games, on communication networks.

### BACKGROUND OF THE INVENTION

Many electronic game systems have Ethernet adapters that may allow users to connect their systems to local networks and/or the Internet to participate in multi-user games. These games may be referred to as massively multiplayer online games (MMOGs), multi-user shared hallucinations (MUSH), massively multiplayer online role-playing games (MMORPGs) and/or multi-user dungeons (MUDs).

Typically, one player coordinates the game and sends invitations to other users to join in. When only a few players participate, the performance of the network may be sufficient. When many players participate, however, the connection between the coordinating player's game box and the network, which may be a digital subscriber line, for example, may not provide sufficient bandwidth to make the game enjoyable for all the participants.

One solution to this bandwidth problem is to use a dedicated server in the network that is configured to host a particular type of game. The server may connect to the network using a high-speed optical link to provide increased bandwidth, for example. Typically, however, the server is configured for a particular game, which means there generally must be a relatively large demand for that particular game to make it economically justifiable to configure a server specifically for the game.

### SUMMARY OF THE INVENTION

According to some embodiments of the present invention, a communication network that includes a server and a plurality of data processing systems is operated by uploading a coordination module from one of the plurality of data processing systems to the hosting server across the communication network. The game hosting server coordinates peer-to-peer communication sessions among a plurality of users associated with the plurality of data processing systems.

In other embodiments of the present invention, the hosting server is a game hosting server and the coordination module is a game-play coordination module.

In other embodiments of the present invention, processing time is reserved on the game hosting server for playing the game.

In still other embodiments of the present invention, other ones of the plurality of data processing systems are invited to participate in the game.

In still other embodiments of the present invention, the quality of service (QoS) is adjusted on the communication links that connect the plurality of data processing systems to the game hosting server.

Other systems, methods, and/or computer program products according to embodiments of the invention will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

Other features of the present invention will be more readily understood from the following detailed description of exemplary embodiments thereof when read in conjunction with the accompanying drawings, in which:

FIG. 1 is a block diagram that illustrates a communication network in accordance with some embodiments of the present invention;

FIG. 2 illustrates a data processing system that may be used to implement a game hosting server and/or a users gaming system in accordance with some embodiments of the present invention;

FIG. 3 is a block diagram that illustrates a software architecture for a gaming data processing system in accordance with some embodiments of the present invention;

FIG. 4 is a block diagram that illustrates a software architecture for a game hosting server data processing system in accordance with some embodiments of the present invention; and

FIG. 5 is a flowchart that illustrates operations of coordinating playing a multi-player game across a communication network in accordance with some embodiments of the present invention.

### DETAILED DESCRIPTION OF EXEMPLARY EMBODIMENTS

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like reference numbers signify like elements throughout the description of the figures. As used herein, the term “and/or” includes any and all combinations of one or more of the associated listed items.

The present invention may be embodied as systems, methods, and/or computer program products. Accordingly, the present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

The present invention is described herein with reference to flowchart and/or block diagram illustrations of methods, systems, and computer program products in accordance with exemplary embodiments of the invention. It will be understood that each block of the flowchart and/or block diagram illustrations, and combinations of blocks in the flowchart and/or block diagram illustrations, may be implemented by computer program instructions and/or hardware operations. These computer program instructions may be provided to a processor of a general purpose computer, a special purpose computer, or other programmable data processing apparatus to produce a machine, such that the instructions, which execute via the processor of the computer or other programmable data processing apparatus, create means for implementing the functions specified in the flowchart and/or block diagram block or blocks.

These computer program instructions may also be stored in a computer usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart and/or block diagram block or blocks.

For purposes of illustration, embodiments of the present invention are described herein with respect to coordinating playing of a multi-player game across a communication network. It will be understood that the present invention is not limited to such embodiments but may also be embodied generally as coordinating a one or more peer-to-peer sessions across a communication network.

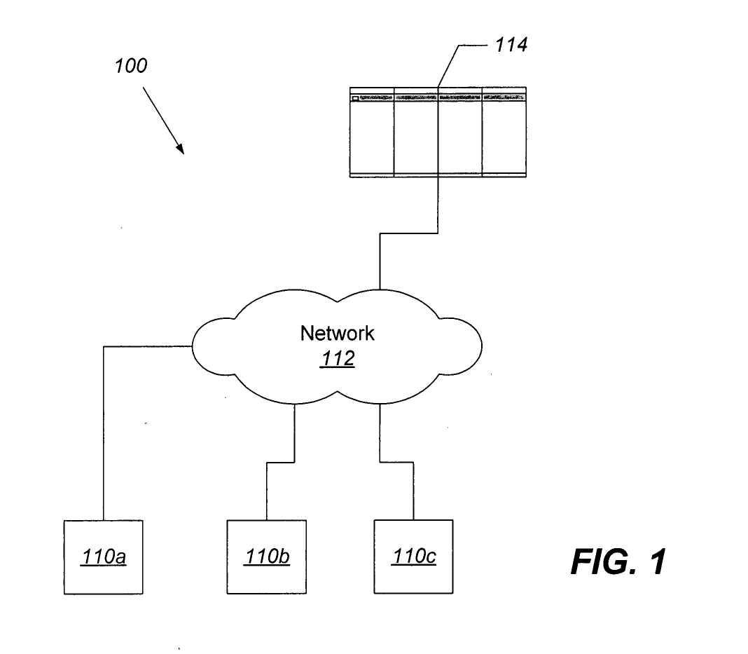

Referring now to FIG. 1, an exemplary network architecture 100 for coordinating playing of a multi-player game across a communication network, in accordance with some embodiments of the present invention, comprises a plurality of data processing systems 110a, 110b, and 110c, which may represent gaming systems associated with a plurality of players or users, respectively. The data processing systems 110a, 110b, and 110c are connected via network 112 to one or more game hosting servers 114. The network 112 may represent a global network, such as the Internet, or other publicly accessible network. The network 112 may also, however, represent a wide area network, a local area network, an Intranet, or other private network, which may not accessible by the general public. Furthermore, the network 112 may represent a combination of public and private networks or a virtual private network (VPN).

The game hosting server(s) 114 may be connected to the network 112 via a high-speed link, such as, for example, an OC-3 connection, which may provide a throughput of 155.52 Mbps. The high speed link to the game hosting server(s) 114 may be used to provide sufficient bandwidth to ensure that the users or players associated with the data processing systems 110a, 110b, and 110c are provided with satisfactory performance when participating in a game through the game hosting server(s) 114.

Although FIG. 1 illustrates an exemplary communication network, it will be understood that the present invention is not limited to such configurations, but is intended to encompass any configuration capable of carrying out the operations described herein.

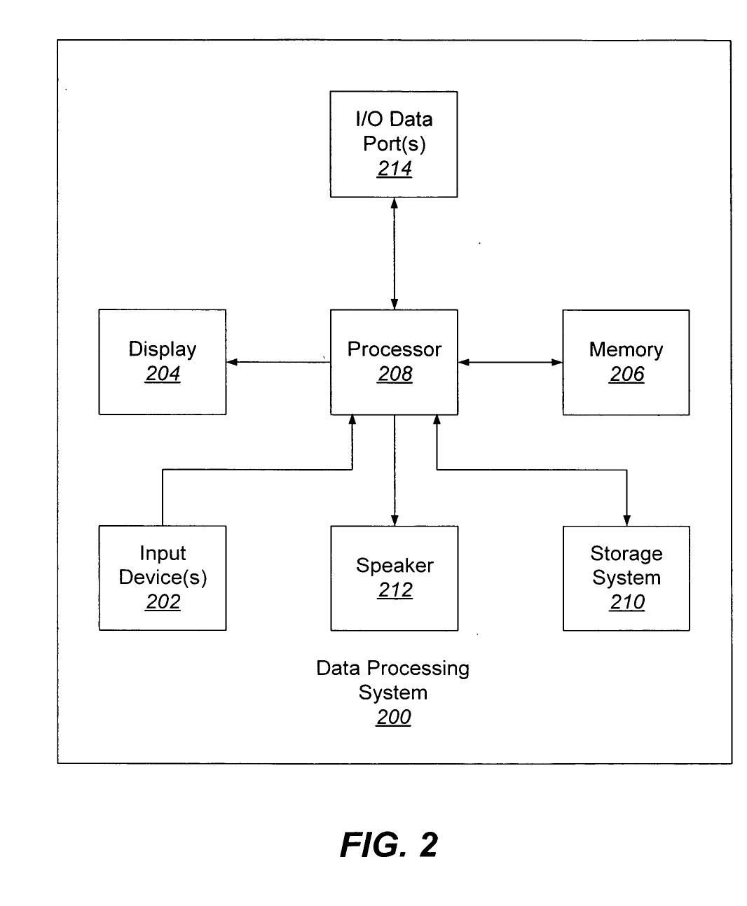

Referring now to FIG. 2, a data processing system 200 that may be used to implement the data processing systems 110a, 110b, and 110b and/or the game hosting server 114 of FIG. 1, in accordance with some embodiments of the present invention, comprises input device(s) 202, such as a keyboard or keypad, a display 204, and a memory 206 that communicate with a processor 208. The data processing system 200 may further include a storage system 210, a speaker 212, and an input/output (I/O) data port(s) 214 that also communicate with the processor 208. The storage system 210 may include removable and/or fixed media, such as floppy disks, ZIP drives, hard disks, or the like, as well as virtual storage, such as a RAMDISK. The I/O data port(s) 214 may be used to transfer information between the data processing system 200 and another computer system or a network (e.g., the Internet). These components may be conventional components such as those used in many conventional computing devices, which may be configured to operate as described herein.

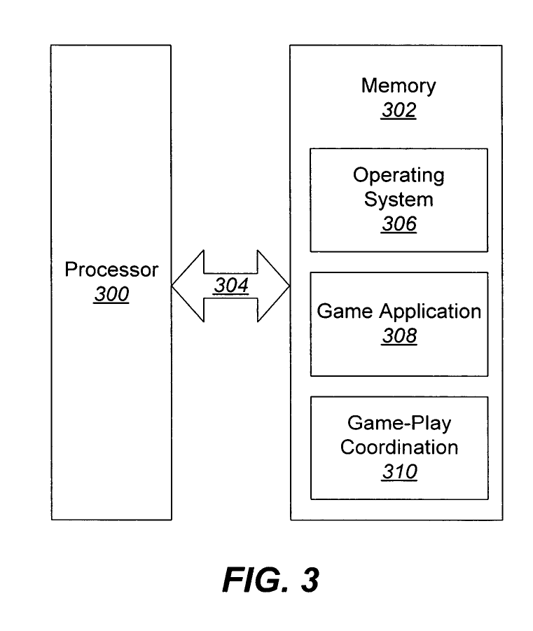

FIG. 3 illustrates a processor 300 and a memory 302 that may be used in embodiments of methods, systems, and computer program products for coordinating playing of a multi-user game in accordance with some embodiments of the present invention. For example, in some embodiments of the present invention, the processor 300 and memory 302 may be used to embody the processor 208 and the memory 206, respectively, of FIG. 2 in the respective data processing systems 110a, 110b, and 110c of FIG. 1. The processor 300 communicates with the memory 302 via an address/data bus 304. The processor 300 may be, for example, a commercially available or custom microprocessor. The memory 302 is representative of the overall hierarchy of memory devices containing the software and data used to participate in a multi-user came across a communication network in accordance with some embodiments of the present invention. The memory 302 may include, but is not limited to, the following types of devices: cache, ROM, PROM, EPROM, EEPROM, flash, SRAM, and DRAM.

As shown in FIG. 3, the memory 302 may hold three or more major categories of software and data: an operating system 306, a game application module 308, and a game-play coordination module 310. The operating system 306 controls the operation of the data processing system. In particular, the operating system 306 may manage the data processing system's resources and may coordinate execution of programs by the processor 300.

The game application module 308 may provide the logic for a multi-user game that may be played across a communication network. The game-play coordination module 310 may be used to upload to the game hosting server 114 of FIG. 1 to allow the game hosting server 114 to host a multi-user game corresponding to the game application module 308.

Although FIG. 3 illustrates an exemplary software architecture that may facilitate participating in a multi-user game across a communication network, it will be understood that the present invention is not limited to such a configuration but is intended to encompass any configuration capable of carrying out the operations described herein.

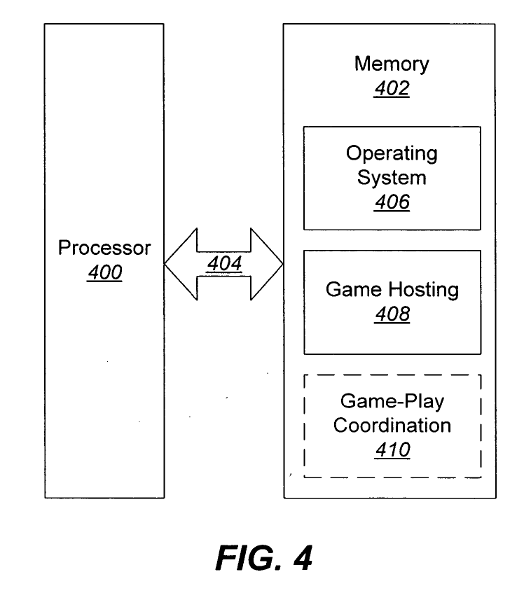

FIG. 4 illustrates a processor 400 and a memory 402 that may be used in embodiments of methods, systems, and computer program products for coordinating playing of a multi-user game in accordance with some embodiments of the present invention. For example, in some embodiments of the present invention, the processor 400 and memory 402 may be used to embody the processor 208 and the memory 206, respectively, of FIG. 2 in the game hosting server(s) 114 of FIG. 1. The processor 400 communicates with the memory 402 via an address/data bus 404. The processor 400 may be, for example, a commercially available or custom microprocessor. The memory 402 is representative of the overall hierarchy of memory devices containing the software and data used to coordinate a multi-user came across a communication network in accordance with some embodiments of the present invention. The memory 402 may include, but is not limited to, the following types of devices: cache, ROM, PROM, EPROM, EEPROM, flash, SRAM, and DRAM.

As shown in FIG. 4, the memory 402 may hold three or more major categories of software and data: an operating system 406, a game hosting module 408, and a game-play coordination module 410. The operating system 406 controls the operation of the data processing system. In particular, the operating system 406 may manage the data processing system's resources and may coordinate execution of programs by the processor 400. The operating system 406 may provide a standard gaming execution environment, such as RPC, Java VRM, or GRID technology.

The game hosting module 408 may be configured to provide the common logic for hosting multiple data processing users running a gaming application across a communication network, such as the communication network of FIG. 1 In particular, the game hosting module 408 may include logic used to manage/adjust the quality of service (QoS) on the links connecting the data processing systems associated with the users or players to the game hosting server 114, for example. As used herein, QoS includes, but is not limited to, treatment applied to an access session, data flow, and/or packet with respect to scheduling a resource, bandwidth allocation, and/or delivery target in an individual element or across an end-to-end system.

The game-play coordination module 410 corresponds to the game-play coordination module 310 after it is uploaded to the game hosting server 114. Advantageously, one of the players in the multi-user game may choose to be the “host” for the game. The game-play coordination module 310 may be uploaded to a central server in the network for coordination of the game among the various players. By uploading the game-play coordination module 310, which becomes the game-play coordination module 410 in the game hosting server 114, the server may be dynamically converted into a server for supporting coordination of a multi-user game for the particular game corresponding to the game application module 308 of FIG. 3. Once the game is complete, the game hosting server 114 may be used to coordinate another multi-user game. Thus, the game hosting server need not be dedicated to a particular gaming application, but can instead be used to coordinate multiple types of gaming applications and can therefore be used by a greater number of gaming participants than if the game hosting server 114 were dedicated to a single gaming application.

Although FIG. 4 illustrates an exemplary software architecture that may facilitate coordinating a multi-user game across a communication network, it will be understood that the present invention is not limited to such a configuration but is intended to encompass any configuration capable of carrying out the operations described herein.

Computer program code for carrying out operations of data processing systems discussed above with respect to FIGS. 3 and 4 may be written in a high-level programming language, such as C or C++, for development convenience. In addition, computer program code for carrying out operations of embodiments of the present invention may also be written in other programming languages, such as, but not limited to, interpreted languages. Some modules or routines may be written in assembly language or even micro-code to enhance performance and/or memory usage. It will be further appreciated that the functionality of any or all of the program modules may also be implemented using discrete hardware components, one or more application specific integrated circuits (ASICs), or a programmed digital signal processor or microcontroller.

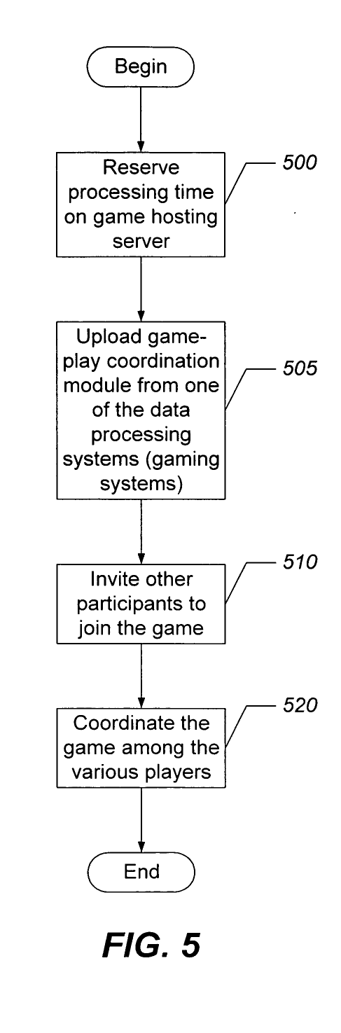

Exemplary operations for coordinating playing of a game across a communication network by uploading a game-play coordination module to a game hosting server will now be described with reference to FIG. 5. Operations begin at block 500 where one of the data processing systems 110a, 110b, and/or 110c of FIG. 1, for example, reserves processing time on the game hosting server(s) 114. One of the data processing systems 110a, 110b, and/or 110c may then upload a game-play coordination module 310 (FIG. 3) to the game hosting server 114 at block 505. The game hosting server 114 may invite other data processing systems associated with game participants to join the game at block 510. Once the game begins, the game hosting server 114 may coordinate the game among the various players and adjust the QoS on the communication links connecting the data processing systems of the various players to ensure that the gaming performance is satisfactory for the participants. Advantageously, the link from the network to the game hosting server 114 may have a much higher bandwidth than is typically provided to a participant's data processing system (e.g., gaming system), which may allow games hosted at the game hosting server 114 to include more players than games hosted at a data processing system of one of the participants.

The flowchart of FIG. 5 illustrates the architecture, functionality, and operations of some embodiments of methods, systems, and computer program products for coordinating playing of a game across a communication network by uploading a game-play coordination module to a game hosting server. In this regard, each block represents a module, segment, or portion of code, which comprises one or more executable instructions for implementing the specified logical function(s). It should also be noted that in other implementations, the function(s) noted in the blocks may occur out of the order noted in FIG. 5. For example, two blocks shown in succession may, in fact, be executed substantially concurrently or the blocks may sometimes be executed in the reverse order, depending on the functionality involved.

Many variations and modifications can be made to the embodiments described herein without substantially departing from the principles of the present invention. All such variations and modifications are intended to be included herein within the scope of the present invention, as set forth in the following claims.

That which is claimed:

1. A method of operating a communication network that includes a hosting server and a plurality of data processing systems, comprising:
uploading a coordination module from one of the plurality of data processing systems to the hosting server across the communication network; and
coordinating peer-to-peer communication sessions among a plurality of users associated with the plurality of data processing systems, respectively, at the hosting server.

2. The method of claim 1, wherein the hosting server is a game hosting server, wherein the coordination module is a game-play coordination module, and wherein coordinating peer-to-peer communication sessions among a plurality of users comprises:
coordinating a game among a plurality of game players associated with the plurality of data processing systems, respectively, at the game hosting server.

3. The method of claim 2, further comprising:
reserving processing time on the game hosting server for playing the game.

4. The method of claim 3, wherein coordinating the game comprises:
inviting other ones of the plurality of data processing systems to participate in the game.

5. The method of claim 2, further comprising:
adjusting quality of service (QoS) on communication links connecting the plurality of data processing systems to the game hosting server.

6. A communication network, comprising:
a plurality of data processing systems; and
a hosting server that comprises:
means for uploading a coordination module from one of the plurality of data processing systems across the communication network; and
means for coordinating peer-to-peer communication sessions among a plurality of users associated with the plurality of data processing systems, respectively, at the hosting server.

7. The communication network of claim 6, wherein the hosting server is a game hosting server, the coordination module is a game-play coordination module, and the means for coordinating comprises:
means for coordinating a game among a plurality of game players associated with the plurality of data processing systems, respectively, at the game hosting server.

8. The communication network of claim 7, wherein the one of the plurality of data processing systems comprises:
means for reserving processing time on the game hosting server for playing the game.

9. The communication network of claim 8, wherein the means for coordinating the game further comprises:
means for inviting other ones of the plurality of data processing systems to participate in the game.

10. The communication network of claim 7, wherein the game hosting server further comprises:
means for adjusting quality of service (QoS) on communication links connecting the plurality of data processing systems to the game hosting server.

11. A computer program product for operating a communication network that includes a hosting server and a plurality of data processing systems, comprising:
a computer readable storage medium having computer readable program code embodied therein, the computer readable program code comprising:
computer readable program code configured to upload a coordination module from one of the plurality of data processing systems across the communication network; and
computer readable program code configured to coordinate peer-to-peer communication sessions among a plurality of users associated with the plurality of data processing systems, respectively, at the hosting server.

12. The computer program product of claim 11, wherein the hosting server is a game hosting server, the coordination module is a game-play coordination module, and the computer readable program code configured to coordinate comprises:
computer readable program code configured to coordinate a game among a plurality of game players associated with the plurality of data processing systems, respectively, at the game hosting server.

13. The computer program product of claim 12, wherein the one of the plurality of data processing systems comprises:
computer readable program code configured to reserve processing time on the game hosting server for playing the game.

14. The computer program product of claim 13, wherein the computer readable program code configured to coordinate the game further comprises:
computer readable program code configured to invite other ones of the plurality of data processing systems to participate in the game.

15. The computer program product of claim 12, wherein the game hosting server further comprises:
computer readable program code configured to adjust quality of service (QoS) on communication links connecting the plurality of data processing systems to the game hosting server.

16. A communication network, comprising:
a plurality of data processing systems; and
a hosting server that is configured to upload a coordination module from one of the plurality of data processing systems across the communication network and to coordinate peer-to-peer communication sessions among a plurality of users associated with the plurality of data processing systems, respectively.

17. The communication network of claim 16, wherein the hosting server is a game hosting server, the coordination module is a game play coordination module, and the game hosting server is further configured to upload the game play coordination module from one of the plurality of data processing systems across the communication network and to coordinate a game among a plurality of game players associated with the plurality of data processing systems, respectively.

18. The communication network of claim 17, wherein the one of the plurality of data processing systems is configured to reserve processing time on the game hosting server for playing the game.

19. The communication network of claim 17, wherein the game hosting server is further configured to invite other ones of the plurality of data processing systems to participate in the game.

20. The communication network of claim 17, wherein the game hosting server is further configured to adjust a quality of service (QoS) on communication links connecting the plurality of data processing systems to the game hosting server.
